(19) United States
(12) Patent Application Publication
(10) Pub. No.: US 2017/0272707 A1
(43) Pub. Date: Sep. 21, 2017

(54) METHOD FOR WRISTBAND CONTROLLER VIDEO RECORDING EVENT MESSAGES

(71) Applicant: Utility Associates, Inc., Decatur, GA (US)

(72) Inventors: Ted Michael Davis, Decatur, GA (US); Simon Araya, Decatur, GA (US); Robert Stewart McKeeman, Decatur, GA (US)

(21) Appl. No.: 15/464,120

(22) Filed: Mar. 20, 2017

Related U.S. Application Data
(60) Provisional application No. 62/310,789, filed on Mar. 20, 2016.

(51) Int. Cl. H04N 7/18; G06F 3/01; H04N 5/232

(52) U.S. Cl. CPC H04N 7/188; H04N 5/23203; H04N 7/185; G06F 3/017

(57) ABSTRACT

This invention includes a device and a method to generate and transmit event messages based upon motion and/or velocity patterns recognized by a Wristband Controller that may contain a three axis accelerometer and may further include a WiFi, BlueTooth, Zigbee, Cellular, or other wireless communications method. The invention avoids the need for a human being to find and press a manual control button on a personal video camera.

### CROSS-REFERENCE TO RELATED APPLICATIONS

This application claims priority to U.S. Provisional Application No. 62/310,789, filed Mar. 20, 2016, the contents of which are expressly incorporated herein by reference in its entirety.

### TECHNICAL FIELD

The present invention is in the technical field of a method of controlling video recording start on a personal video recorder.

### BACKGROUND

More particularly, the present invention is in the technical field of using an accelerometer in a wristband controller as a method of triggering the recording of video from a personal video camera. Personal cameras worn by police officers can record video, audio, and metadata evidence that is useful to document facts related to a public safety incident. There are increasing calls for all police officers to wear personal cameras while on duty.

However, many of the personal video cameras being sold and used by police departments are only manually controlled. A police officer has to be able to manually Start video recording. The officer of course has to be able to physically reach a video start button on the personal video camera, and be able to press the recording start button to start video recording. If the officer is distracted by other events, is actively engaged in a dangerous situation, is in a struggle or running after a suspect, or is otherwise incapacitated, he or she may not remember to, or not be able to, reach and immediately touch the recording Start button at the beginning of an incident. So if the recording Start button is not pressed at the start of the Incident, no video, audio, or metadata from the start of an Incident will be saved.

Police officers have to make split-second life or death judgments, and need to focus on their most important immediate tasks. There is only so much a human being can deal with at one time—task saturation and overload. Clearly the police officer's first and primary objective has to be personally surviving an Incident. So despite extensive training and best intentions, it has to be expected there will be times when personal video recording does not get Started on a manually controlled personal camera at the beginning of an Incident. It is not at all surprising that manually pressing the Start button on a personal video recorder sometimes does not happen.

As an example, a recent analysis of Use of Force incidents for New Orleans police during a July-September 2014 time period, where NOLA PD officers have personal cameras, showed that for 25 Use of Force incidents, there was no video recorded in 9 of those Use of Force Incidents. So for a third of Use of Force Incidents, the police officers forgot to or fail to be able to turn on their personal camera. A 36% failure rate to record video damages public confidence about police accountability and transparency.

There is also an issue of feedback on a manually Started video recording. The officer may believe he pressed the recording Start button—but did the video camera actually start recording? How does the police officer know? Some manually controlled personal cameras have visual recording indicator lights. However, in most cases where the personal camera is located on the officer's chest, the officer cannot see the light. With all the other events and tasks the officer has to deal with on a split-second basis, there can be instances where the officer thought the personal video camera was recording, but in fact it was not. If the police officer is dealing with one or more hostile subjects or a tough confusing situation, wondering whether the body-worn video camera is actually recording is another distraction a Police Officer does not need. It is far better for the police officer's personal safety for the officer to be confident the personal video camera has Started recording.

Therefore, a personal video recording method is needed that does not involve an officer having to reach for and find a personal camera, which is typically clipped to the officer's chest and out of the officer's direct line of view, use tactile feel to find the Start button, and then press a Start button to begin recording.

### SUMMARY

A mobile lot device being used as a personal video camera can receive a wireless event message that automatically Starts video recording. Upon receipt of one or more event messages, or a combination of event messages, the personal video camera application software can decide to Start video recording. The desire is suitable to be an area on a body part, such as a wrist.

A Cellular, WiFi, BlueTooth, Zigbee or other wireless communications-enabled wristband controller with GPS, Accelerometer, Heart Rate, and other sensors can generate and transmit an event message that could be received by a personal video camera and used as basis for the personal video camera's software to Start or Stop recording. In particular, one or more gestures or particular X, Y, and Z axis motion and velocity patterns of an arm or wrist wearing the wristband controller can be sensed by an internal accelerometer in the wristband controller. These sensed gestures or movements can be recognized to create and transmit event messages for a nearby personal camera within wireless communications range. An example would be a wristband controller that would sense a police officer making a sharp arm movement that is consistent with a hand withdrawing a weapon from a holster. The hand goes to the handle of the weapon, and then makes a sharp upward movement to withdraw the weapon vertically upward from the holster. No technology or signaling equipment is required in either the holster or the weapon. The rapid upward acceleration of the wristband controller on the arm can be sensed, and then the wristband controller could transmit an event message that could be received by a nearby personal camera.

This gesture could also transmit an event message to a central video management system indicating to Central Dispatch and/or Supervisors that it is possible a weapon has just been withdrawn from a holster. Any personal video camera within wireless range of the wristband controller could receive the event message to Start video recording. In a likewise manner, placing a weapon back into a holster could generate an event message that would Stop personal video recording.

Of course any number of combinations of X, Y, and Z axis motions with high and low ranges of acceleration could be used as event messages. A slow horizontal wave of the arm might be used to generate an event message that could be used to Stop Video and/or Audio Recording. Any vigorous shake of the wristband controller might also generate an event message that a body-worn camera would receive and use as the basis for Starting or Stopping recording. The combination of gesture patterns and speeds are practically limitless, and there is no intent in this patent application to define specific event types indicated by various gesture patterns. The point of this patent is to point out that various gesture patterns and speeds detected by a wristband controller could be used to generate event messages that could be used as inputs by a personal camera to make a machine decision to Start or Stop Audio and/or Video Recording.

A wristband controller might also be used to detect a covert gesture that indicates an alarm or a status message that may not be recognized by a perpetrator. As an example, a gesture of an officer raising their hands high in the air in a surrender position and maintaining that position could cause an event message to be sent. A personal camera might receive this type of event message and send an alarm message to Central Dispatch, Start video recording, or take some other action. Circular hand motion gestures or other specific movement patterns could generate unique event messages.

Wild rapid motions with no set pattern being detected by the wristband controller could indicate the officer is running or involved in a struggle. An undefined and rapid random X, Y, Z motion pattern would likewise generate an event message as input to the personal video camera.

Various gestures detected by a wristband controller might also generate event messages that would be transmitted to a personal video camera recording device to start real-time audio and/or video streaming, or cause Speech to Text processing to turn on and begin transmitting text messages of conversations being heard by the personal camera device that has Speech to Text processing capability. The combinations and permutations of gestures and event messages are practically unlimited.

In a similar fashion, other sensors or technologies found on the wristband controller working in conjunction with a personal camera might be used to generate event messages. As an example, a wristband controller might have an NFC chipset. A police officer bringing the wristband controller with an NFC chip within NFC read range of the personal video recording device might cause the personal camera device to read the NFC chip and generate an event message that could be used to cause video and/or audio recording to be started or stopped. This NFC proximity message might also be transmitted to a central video management system. On possible embodiment would be a police officer bringing his or her wristband controller within NFC read range to the personal video camera device to Start or Stop recording.

This event message process allows all video recording devices nearby to an Incident to all Start recording automatically, regardless of whether they are previously associated or linked together. Each device independently makes recording Start and Stop decisions. Because the business rules are implemented as software in smart connected Mobile IoT devices, the business rules for when and where to record video can be centrally managed and changed at any time.

When an Incident is in progress, and multiple officers and vehicles respond to the Incident, video recording should automatically Start on all nearby devices rather than just the ones that are linked in a slave to master relationship to a particular In-Car Video Recording system. This event message-based video recording Start process is not going to be racially biased, can better protect the public's Privacy rights, is more likely to capture facts about the Incident, yet will not waste money paying to store video that adds no value. A simple “Start Personal video recording whenever the police car's In-Car Video system is recording” slave to master relationship copies the 5+ year old technology that personal wireless microphones (audio but no video) record audio whenever the In-Car Video system is recording video and audio. Any sort of automatic recording Start process is better than none, but there is no benefit to limit automatic video recording Start to a “master to slave” technology. If a police officer with a personal video camera is nearby an active Incident, their personal video camera should be recording no matter what.

### BRIEF DESCRIPTION OF THE DRAWINGS

FIG. 1 is a schematic view of a gesture of a Wristband Controller Device generating an Event message based upon the X, Y, Z axis motion and velocity pattern detected by the Wristband Controller.

### DETAILED DESCRIPTION

A mobile lot device being used as a personal video camera can receive a wireless event message that automatically Starts video recording. Upon receipt of one or more event messages, or a combination of event messages, the personal video camera application software can decide to Start video recording. The device is suitable to be an area on a body part, such as a wrist.

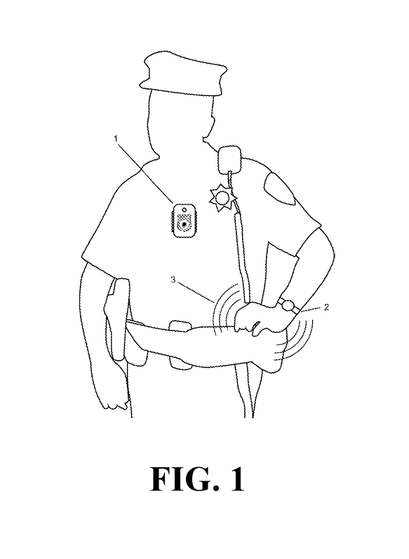

Regarding FIG. 1, a police officer is wearing a Wristband Controller 2 that wirelessly communicates with a personal video recorder 2. Moving or shaking the Wristband Controller device in a specific pattern and velocity generates an Event message that is received by the personal video recording device 1. The person wearing the Wristband Controller 2 can shake or move his or her arm to Start video recording on the personal video recorder 1, or to have the personal video recorder 1 transmit an emergency message, turn on voice recognition to convert Speech to Text, transmit the Text and an emergency alert to Central Dispatch, or perform any number of other actions based upon the specific event message related to a gesture pattern detected by the wristband controller 2 and transmitted to nearby personal video recording devices 1. The controller can include an accelerometer to detect and monitor movement of the controller. The controller may preferably include a central processing unit (CPU), or communicate with a remote CPU, to perform calculations detected by the accelerometer to compare such movements to a predetermined set of movements indicating a certain action. For example, the controller may include memory which stores information correlating to certain movements of the controller. The CPU and memory is well known to those of ordinary skill in the art and need not be disclosed further herein. For example, the storage medium may contain a predetermined pattern or velocity measurement indicating that a particular or given movement of the controller 2 indicates a rapid random X, Y, Z axis motion of the controller 2, indicates an event is in progress. The controller 2 may further include a transmitter to send a message to a personal camera indicating that an event is in progress, and this activates or terminates recording of the camera.

A Cellular, WiFi, BlueTooth, Zigbee or other wireless communications-enabled wristband controller 2 with GPS, Accelerometer, Heart Rate, and other sensors can generate and transmit an event message that could be received by a personal video camera and used as basis for the personal video camera's software to Start or Stop recording. In particular, one or more gestures or particular X, Y, and Z axis motion and velocity patterns of an arm or wrist wearing the wristband controller 2 can be sensed by an internal accelerometer in the wristband controller. These sensed gestures or movements can be recognized to create and transmit event messages for a nearby personal camera 1 within wireless communications range. An example would be a wristband controller 2 that would sense a police officer making a sharp arm movement that is consistent with a hand withdrawing a weapon from a holster. The hand goes to the handle of the weapon, and then makes a sharp upward movement to withdraw the weapon vertically upward from the holster. No technology or signaling equipment is required in either the holster or the weapon. The rapid upward acceleration of the wristband controller 2 on the arm can be sensed, and then the wristband controller could transmit an event message that could be received by a nearby personal camera 1.

This gesture could also transmit an event message to a central video management system (not shown) indicating to Central Dispatch and/or Supervisors that it is possible a weapon has just been withdrawn from a holster. Any personal video camera within wireless range of the wristband controller could receive the event message to Start video recording. In a likewise manner, placing a weapon back into a holster could generate an event message that would Stop personal video recording.

Of course any number of combinations of X, Y, and Z axis motions with high and low ranges of acceleration could be used as event messages. A slow horizontal wave of the arm might be used to generate an event message that could be used to Stop Video and/or Audio Recording. Any vigorous shake of the wristband controller might also generate an event message that a body-worn camera would receive and use as the basis for Starting or Stopping recording. The combination of gesture patterns and speeds are practically limitless, and there is no intent in this patent application to define specific event types indicated by various gesture patterns. The point of this patent is to point out that various gesture patterns and speeds detected by a wristband controller could be used to generate event messages that could be used as inputs by a personal camera to make a machine decision to Start or Stop Audio and/or Video Recording.

A wristband controller 2 might also be used to detect a covert gesture that indicates an alarm or a status message that may not be recognized by a perpetrator. As an example, a gesture of an officer raising their hands high in the air in a surrender position and maintaining that position could cause an event message to be sent. A personal camera 1 might receive this type of event message and send an alarm message to Central Dispatch, Start video recording, or take some other action. Circular hand motion gestures or other specific movement patterns could generate unique event messages.

Wild rapid motions with no set pattern being detected by the wristband controller 2 could indicate the officer is running or involved in a struggle. An undefined and rapid random X, Y, Z motion pattern would likewise generate an event message as input to the personal video camera 1. Various gestures detected by a wristband controller 2 might also generate event messages that would be transmitted to a personal video camera recording device to start real-time audio and/or video streaming, or cause Speech to Text processing to turn on and begin transmitting text messages of conversations being heard by the personal camera device 1 that has Speech to Text processing capability. The combinations and permutations of gestures and event messages are practically unlimited.

In a similar fashion, other sensors or technologies found on the wristband controller 2 working in conjunction with a personal camera might be used to generate event messages. As an example, a wristband controller 2 might have an NFC chipset. A police officer bringing the wristband controller 2 with an NFC chip within NFC read range of the personal video recording device might cause the personal camera device 1 to read the NFC chip and generate an event message that could be used to cause video and/or audio recording to be started or stopped. This NFC proximity message might also be transmitted to a central video management system. On possible embodiment would be a police officer bringing his or her wristband controller 2 within NFC read range to the personal video camera device to Start or Stop recording.

This event message process allows all video recording devices 1 nearby to an Incident to all Start recording automatically, regardless of whether they are previously associated or linked together. Each device independently makes recording Start and Stop decisions. Because the business rules are implemented as software in smart connected Mobile (Internet of Things) devices, the business rules for when and where to record video can be centrally managed and changed at any time.

When an Incident is in progress, and multiple officers and vehicles respond to the Incident, video recording should automatically Start on all nearby devices 2 rather than just the ones that are linked in a slave to master relationship to a particular In-Car Video Recording system. This event message-based video recording Start process is not going to be racially biased, can better protect the public's Privacy rights, is more likely to capture facts about the Incident, yet will not waste money paying to store video that adds no value. A simple “Start Personal video recording whenever the police car's In-Car Video system is recording” slave to master relationship copies the 5+ year old technology that personal wireless microphones (audio but no video) record audio whenever the In-Car Video system is recording video and audio. Any sort of automatic recording Start process is better than none, but there is no benefit to limit automatic video recording Start to a “master to slave” technology. If a police officer with a personal video camera 1 is nearby an active Incident, their personal video camera should be recording no matter what.

An advantage of the present invention is to provide an alternative means to Start video recording when any number of single or combination events indicates that video, audio, and metadata evidence should be recorded. The software running on the Wristband Controller 2 can be configured to recognize any number of movement patterns and velocities and broadcast event messages. Each police department or other type of user can tailor gesture recognition as desired.

The present invention can further recognize gestures that do not require conscious effort from the person wearing the Wristband Controller 2. One specific example is withdrawing a weapon from a holster. The Wristband Controller 2 can be configured to recognize this motion and velocity pattern performed by the wearer without any forethought or conscious effort as a function of the role, and generate an event message accordingly. Video recording by the personal camera device 1 can be started automatically as an unconscious byproduct of the wearer performing their job.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. To the extent necessary to understand or complete the disclosure of the present invention, all publications, patents, and patent applications mentioned herein are explicitly incorporated by reference therein to the same extent as though each were individually so incorporated.

Having thus described exemplary embodiments of the present invention, those skilled in the art will appreciate that the within disclosures are exemplary only and that various other alternatives, adaptations, and modifications may be made within the scope of the present invention. Accordingly, the present invention is not limited to the specific embodiments as illustrated herein, but is only limited by the following claims.

1. A controller for activating a recording device, comprising;
a mobile device suitable to be worn on an external body part that projects away from the body;
a sensor provided with said mobile device such that said sensor is able to sense movement of said body part;
a device for creating an event message in response to movement of said sensor; and
a transmitter for transmitting said event message to a recording device,
whereby, upon receipt of said event message, said recording device is activated.

2. A method for activating a recording device, comprising:
providing a personal body camera;
providing an electronic device suitable to be worn about the wrist, said electronic device including an accelerometer for detecting movement of the electronic device;
providing a processing unit for processing the movement of the electronic device;
upon recognition of a given movement of the electronic device, transmitting a signal to said personal recording device so as to begin or stop recording.

3. The method of claim 2 further comprising storing a predetermined movement in a memory associated with said processing unit.

4. The method of claim 3 wherein said transition of said signal is accomplished wirelessly.
